(19) United States
(12) Patent Application Publication
(10) Pub. No.: US 2009/0233255 A1
(43) Pub. Date: Sep. 17, 2009

(54) Set of prefabricated and flexible dental arches with adjustable teeth, dental arches kit, denture construction process and method of application of said arches in the denture construction process

(75) Inventors: Almenara De Souza Fonseca Silva, Campinas (BR); Jose Luiz Lino Trochmann, em Campina (BR); Leila Peres, em Campina (BR); Lucia Helena Innocentini Mei, em Campina (BR); Simonides Consani, em Piracicaba (BR)

Correspondence Address: THE NATH LAW GROUP, 112 South West Street, Alexandria, VA, 22314, US

(73) Assignee: UNIVERSIDADE ESTADUAL DE CAMPINAS- UNICAMP, Campinas, SP (BR)

(21) Appl. No.: 12/227,690

(22) PCT Filed: May 25, 2007
(86) PCT No.: PCT/BR2007/000123

§ 371 Date: May 11, 2009

(30) Foreign Application Priority Data
May 25, 2006 (BR) PI0602107-7

(51) Int. Cl. A61C 9/00; A61C 13/34

(52) U.S. Cl. 433/71; 433/215

(57) ABSTRACT

The present invention discloses a set of dental arches comprising: an upper arch (1) formed by upper anterior (2) and posterior (3) artificial teeth and another lower arch (5) formed by lower anterior (6) and posterior (7) artificial teeth mounted in an orderly fashion on flexible bases (4) and (8) constructed of elastomeric resin in the form of an arch, having a three-dimensional movement capacity to enable adaptation to the anatomy and physiology of edentulous patients; the base material also allows the adjustment of each tooth individually, through changes of position, inclination or alignment, in a simple manner, thus producing custom prosthodontics; its use in the confection processes of removable complete and partial dentures saves time, labor and cost compared to traditional methods.

### FIELD OF THE INVENTION

The present patent of invention discloses a set of prefabricated and flexible dental arches with adjustable teeth. Said set of arches is formed by groups of upper and lower artificial teeth, mounted on a support base made of elastomeric material, thus reducing manpower and time for arrangement of teeth, when applied to the conventional techniques for denture construction. When used in association with simplified techniques, a significant cost reduction is also achieved, also avoiding physical inconvenience for the patient. The set of arches disclosed herein is intended for the confection of removable complete and partial dentures prosthodontics. Additionally, the present invention refers to a kit of said dental arches, a denture construction process using said arches and a method of application thereof in the denture construction process.

### BACKGROUND OF THE INVENTION

Oral rehabilitation of edentulous patients has been carried out by substituting the natural teeth lost for artificial teeth. Treatment is normally by means of removable complete dentures, constructed by various methods described in innumerous publication.

These methods comprise a sequence of stages involving clinical and laboratorial procedures that include primary and secondary impressions, confection of plaster casts, confection of recording bases and occlusion rims. The purpose of the planes is to serve as a reference for positioning the artificial teeth, which in turn, should be suitably positioned to meet the patient's physical, physiological and aesthetic needs, as well as comfort.

Depending on the technique used to position the teeth, these planes may be constructed of a variety of materials attached to the recording bases. When the denture is constructed using conventional methods, such as the aesthetic method, the phonetic method or those based on the use of anatomic landmarks and biometric guides, the occlusion rims are constructed of wax, and used to establish the labial contour and buccal corridor, determine the height and inclination of the occlusal plane and record the intermaxillary relations.

When functional methods are used for denture construction, such as the piezograph, a neutral zone technique or determination of denture space, the occlusion rims are made of pliable materials such as tissue conditioner, silicones, self-curing acrylic resins or modeling compound, which allow casting by the pressure exerted by the tongue, lips and cheeks musculature. The use of these techniques has significantly increased over recent years, because the artificial teeth are positioned in accordance with the muscular behavior of the patient himself, creating a harmonious relationship with the surrounding oral structures. This allows the musculature to execute its movements freely during the functional activities and consequently makes the complete denture more retentive, stable and comfortable.

The artificial teeth available on the market for denture construction are made of synthetic resin or porcelain and commercialized as unit elements arranged on plates. Normally, the six anterior (upper and lower) teeth are arranged on two plates, and the eight posterior (upper and lower from both sides) teeth, totaling 28 teeth, are presented on two other plates.

Generally during the arrangement stage, the teeth are removed from the plate and attached one by one on the recording base with the aid of wax, simulating the patient's natural teeth. In order to establish a suitable occlusal pattern, this procedure is normally carried out in a laboratory with the plaster casts mounted on the articulator. This equipment is able to reproduce the mandible position in relation to the maxilla and temporomandibular joints, as well as the mandibular movements.

Next, the patient is submitted to a trial arrangement of teeth made of wax to evaluate whether the aesthetics, phonetics, occlusion and adaptation are suitable. Finally, the carving of the base and the processing of the acrylic dentures are made in the laboratory, corresponding to the processing phase in which the temporary materials used during the production stages are substituted for acrylic resin, which constitutes the main component of the definitive bases.

In dentistry, the process of denture construction has been considered one of the most complex procedures, particularly the stage of mounting the teeth to meet the patient's needs, characterized by requiring many hours of labor by the dentist or denture technician.

Some attempts to simplify denture construction have included the use of prefabricated arches of artificial teeth. Among the models proposed in the state of the art is a set of upper and lower arches formed by 14 artificial teeth interconnected to construct prefabricated standardized dentures. The technique is based on taking the patient's impressions, followed by determining the vertical dimension. Next comes selecting the suitable size of the dental arch, which is placed on a softened wax base to obtain the centric occlusion. Subsequently, adjustments to the support base, wax carving and the processing of the acrylic dentures are carried out.

Another rigid arch cast is disclosed together with other components, including denture bases, palate and lower plates and screws make up the set of semi-manufactured products to construct complete prefabricated double dentures. According to the configuration of the patient's oral cavity, which comprises ovoid, square or tapering forms, three kinds of semi-manufactured products (small, medium or large size) may be chosen. Adapting the set to the patient's mouth is obtained by means of indirect relining.

The cast taught in patent applications U.S. Pat. No. 4,533,325, PI8403234-0, U.S. Pat. No. 4,705,476 can also be cited. It describes arches of artificial teeth made of acrylic resin, provided with a support and stabilization structure containing finger-like components radially extending from a central member, whose ends are attached to the inner surface of some posterior teeth. This structure extends between the teeth present in opposite sides of the arch.

Patent application U.S. Pat. No. 4,780,082 discloses an arch made of a rigid structure base and temporarily attached artificial teeth, with the presence of an interconnecting device to keep the upper and lower members together, guaranteeing a stable relationship during denture construction. Another model is taught in patent application U.S. Pat. No. 5,320,527, which describes an arch that is also formed by a rigid base on which the teeth are attached. The maxillary arch has a fitting system in the region of the incisal papilla and hamular notch that can connect to the corresponding representations present in the patient's upper cast, providing arch guidance in relation to the cast and eliminating the need to use an articulator or other instrument.

Although the prefabricated rigid dental arches facilitate the process of denture construction, one of the disadvantages of its application is the difficulty in adapting these arches, with pre-established contours, to the oral cavity of the patients and the impossibility of movement of the teeth. These conditions result in the production of standardized dentures, which may be damaging in terms of aesthetics, function and comfort.

Some arch models having flexible characteristics and thus having greater adaptability are described in patent applications DE2255134, U.S. Pat. No. 6139321 and U.S. Pat. No. 4470815.

The first case refers to an arch constructed of artificial teeth mounted on a base made of thermoplastic material, which has variable curvature, and can be increased or reduced to adjust to the individually manufactured denture bases, where it will subsequently be connected. The occlusal surfaces of the posterior teeth are flat so that the occlusion and articulation are not damaged by the changes in the arch curvature. The limitation in this model is that the thermoplastic material requires the use of heat for bending and this softening temperature may cause handling difficulties or be incompatible with other materials used in the process. Other disadvantages are the reduced possibility of movement of the arch and especially of the teeth.

In the second case, the arch comprises a support ribbon made of plastic or metallic material on which a set of artificial teeth is temporarily mounted. Joining is achieved by means of a slot in the base of each tooth, which engages with a key in the ribbon. The radius of the arch may be expanded or contracted by an extensible device connected at each end to the ribbon, which extends from one side to the other of the arch. The disadvantage associated to the use of this model is related to the difficulty in releasing the teeth to perform individual movements, to the extent that changes of position are restricted. Additionally, the presence of the extendible device traversing the arch from one side to the other limits its application, when functional techniques for denture construction are adopted, as there is a coincidence of the positions of the device and of the lingual matrix used in these techniques, causing problems in the arrangement of the arches.

U.S. Pat. No. 4,470,815, which describes a prefabricated denture module made of uncured synthetic resin, cites some partial or complete arch molds that can be used in the process. These molds include arches made of the same uncured material as the module and the arches where the teeth are attached by an internally extended wire. Difficulties arising with arches made of uncured synthetic resin relate to the possibility of deformation and the need to store at a temperature of 0° C. to achieve rigidity of the material and prevent curing. In the case of blocks of teeth attached by wire, the presence of the acrylic fixing resin used limits the individual movement of the teeth.

By virtue of the foregoing, it is clear that the attempts to simplify the process of denture construction, through the use of prefabricated arches, are limited due to the fact that existing products do not have suitable properties.

### BRIEF DESCRIPTION OF THE INVENTION

The present patent of invention was developed based on the state of the art, and with a view to overcoming the problems and limitations described previously.

The set of prefabricated and flexible dental arches with adjustable teeth, which is the subject matter of this present patent, is formed by teeth arranged on flexible bases that are able to adapt to the anatomy and physiology of the edentulous patients by way of alterations to the diameter and form of arch, as well as to the height and inclination of the occlusal plane.

The base material also allows the adjustment of each tooth individually through changes of position, inclination or alignment, in a simple manner, following known and routine laboratory techniques, thus producing custom prosthodontics.

The set of arches referred to herein solves various disadvantages foreseen in the state of the art molds, since the elastomeric resin base is flexible at room temperature and has three-dimensional movement.

Additionally, the arches are easily stored and have the versatility required to meet the requirements of the conventional, functional and simplified techniques for denture construction, at the discretion of the professional.

### BRIEF DESCRIPTION OF THE DRAWINGS

The present patent of invention will now be described in greater detail, based on the drawings listed below, wherein:

FIG. 1 is a schematic illustration of an occlusal view of the set of prefabricated and flexible dental arches with adjustable teeth;

FIG. 2 is a schematic illustration of a perspective view of the set of prefabricated and flexible dental arches with adjustable teeth;

FIG. 3 illustrates an exploded perspective of the set of arches illustrated in FIG. 2; and

FIG. 4 is a schematic illustration of a perspective of the upper arch of the construction variation of the set of prefabricated and flexible dental arches with adjustable teeth.

### DETAILED DESCRIPTION OF THE INVENTION

The present invention discloses a set of prefabricated and flexible dental arches with adjustable teeth. Said set of arches is formed by groups of upper and lower artificial teeth mounted on a flexible support base made of elastomeric polymeric material in the conditions of use, which allows adjustments to be made in each tooth individually through changes of position, inclination or alignment, in a simple manner, following known and routine laboratory techniques, thus producing custom prosthodontics.

The elastomeric material from which the flexible support base is made, is flexible at room temperature and has three-dimensional movement capacity. These characteristics make the present invention more advantageous in relation to the dental arches known in literature to-date. In order to facilitate the understanding of this present invention, the flexible support base made of elastomeric polymeric material in the conditions of use will be referred to herein as flexible support base.

The present embodiment is designed for the confection of removable complete and partial dentures.

The set of prefabricated and flexible dental arches with adjustable teeth, is formed by teeth arranged on flexible support bases that are able to adapt to the anatomy and physiology of edentulous patients by way of alterations to the diameter and to the form of the arch, as well as to the height and inclination of the occlusal plane.

Additionally, the dental arches, which are the subject matter of this present invention, are easily stored and have the versatility needed to meet the requirements of the conventional, functional and simplified techniques for denture construction, at the discretion of the professional.

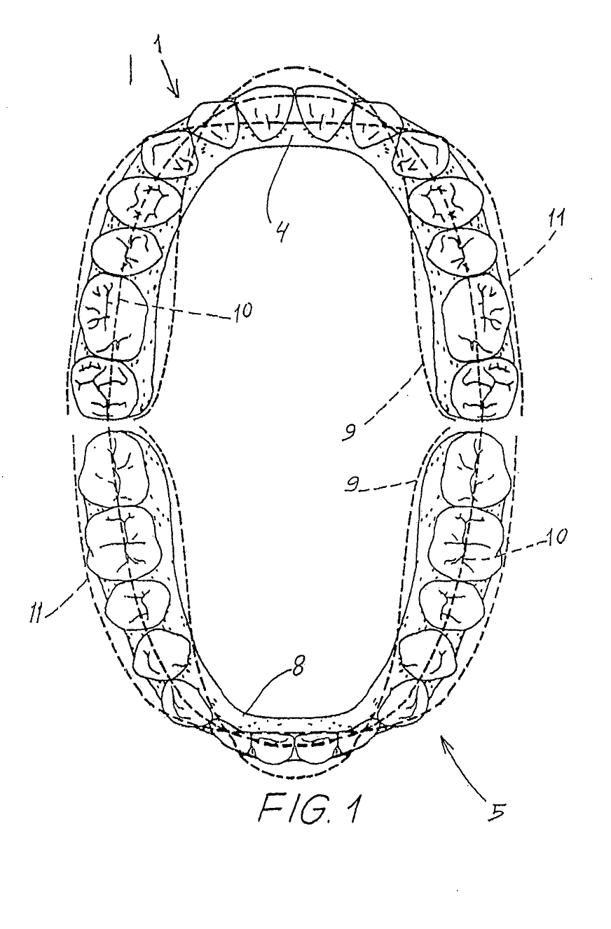

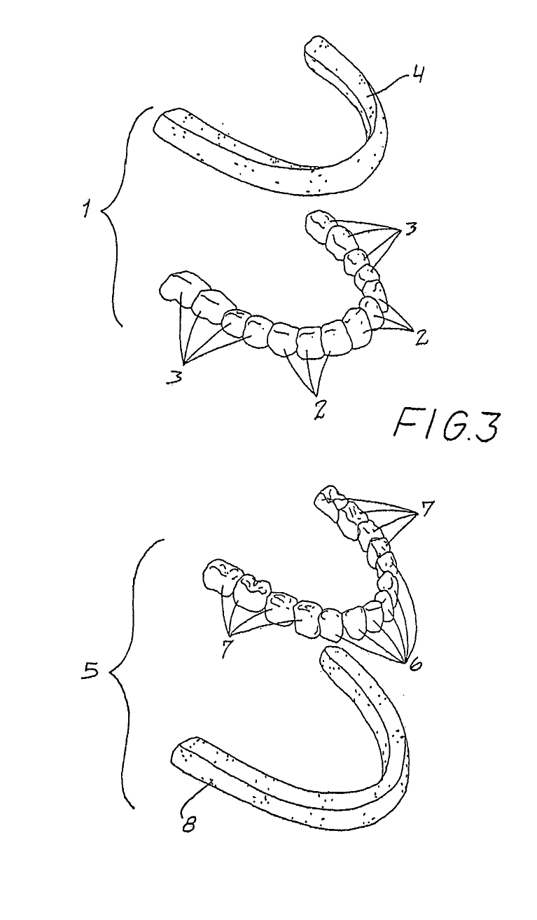

Based on the content illustrated in FIGS. 1, 2 and 3, the set of prefabricated and flexible dental arches with adjustable teeth comprises:

an upper arch 1, formed by upper anterior 2 and upper posterior 3 artificial teeth;

a lower arch 5, formed by lower anterior 6 and lower posterior 7 artificial teeth.

In the upper arch 1, the upper anterior 2 and upper posterior 3 artificial teeth are mounted in an orderly fashion on a first flexible support base 4 and in the lower arch 5, the lower anterior 6 and lower posterior 7 artificial teeth are mounted in an orderly fashion on a second flexible support base 8. Said flexible support bases 4 and 8 are made of an elastomeric resin in the form of an arch, substantially similar to the natural upper and lower dental arches.

Said upper arch 1 and lower arch 5 are constructed so as to provide the characteristics needed to comply with the principles of the functional methods of denture construction. However, they are not limited to the functional methods, and may also be used in any other denture construction technique.

The flexible support bases 4 and 8 have three-dimensional movement capacity, which enables alterations to the diameter and form of the dental arches, which in the present embodiment are referred to as representative arches 9, 10 and 11, and to the inclination of the occlusal plane 12 and 13, to facilitate the adaptation of said dental arches to the occlusion rim and to the occlusal pattern established by the professional.

The present embodiment allows adjustments to be carried out in each tooth individually, by way of changes of position, inclination or alignment. Said adjustments are carried out in a simple manner, following routine laboratory procedures. They allow the correction of aesthetic, phonetic or occlusal problems that may arise during the arrangement of teeth or wax trial denture.

The upper anterior 2 and the upper posterior 3 artificial teeth, just as the lower anterior 6 and the lower posterior 7 artificial teeth, are made of synthetic resin or porcelain.

Said upper artificial teeth 2 and 3 and temporarily and/or definitively attached to the flexible support base 4, whereas said lower artificial teeth 6 and 7 are temporarily and/or definitively attached to the second flexible support base 8.

For the present embodiment, all the commercially available artificial teeth molds may be used, according to their specific manufacturing characteristics.

Additionally, the subject matter of this present embodiment is applicable to any kind of occlusal anatomy for the posterior teeth, and may have variations in the inclination on the cusps slopes, preferably between 0 and 33° Celsius.

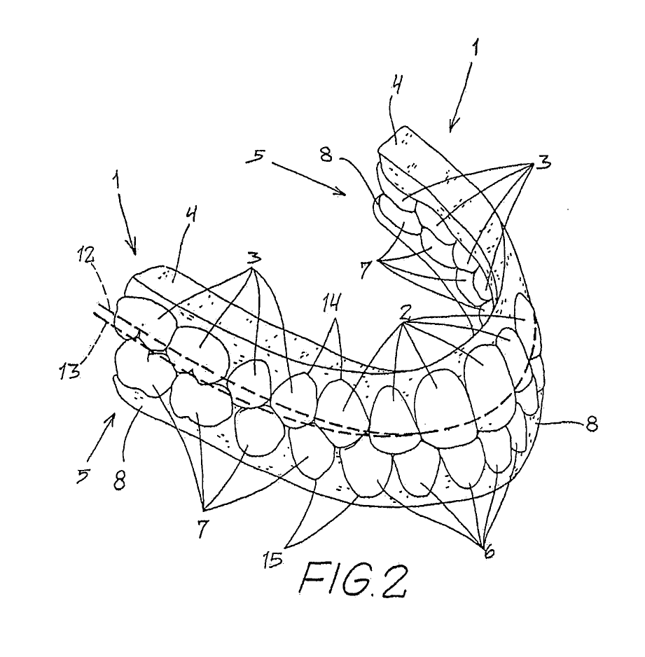

Both the upper arch 1 and the lower arch 5 can be mounted establishing occlusal planes 12 and 13 with varied inclinations, as shown in FIG. 2, allowing any occlusal pattern to be obtained during arrangement.

To construct the upper arch 1 and lower arch 5, the upper anterior 2, posterior 3, lower anterior 6 and lower posterior 7 artificial teeth are preferably aligned in templates. The upper template and the lower template are provided with a negative impression of the occlusal and axial contours of the respective teeth.

The connection of said artificial teeth 2, 3, 6 and 7 to the material that constitutes the flexible support bases 4 and 8, which form the upper arch 1 and the lower arch 5 is established by mechanical retention means, obtained by the presence of a cavity in the basal surface of each tooth. Said cavity should subsequently be filled with elastomeric material, when said material is. applied to the teeth preferably by means of compression process, whereby the upper 1 and lower 5 arches will be formed.

Alternatively, the arches 1 and 5 belonging to the set of prefabricated and flexible dental arches with adjustable teeth, the subject matters of this present invention, may also be segmented, in other words, may be separated in order to meet the specific needs of partially or fully edentulous patients.

If arches 1 and 5 are segmented, said arches 1 and 5 are preferably comprised of the anterior sextants and/or of the posterior quadrants.

Another preferred embodiment of this present invention provides a construction variation of the set of prefabricated and flexible dental arches with adjustable teeth, in order to facilitate adaptation of the arches to the vertical dimension of the patient.

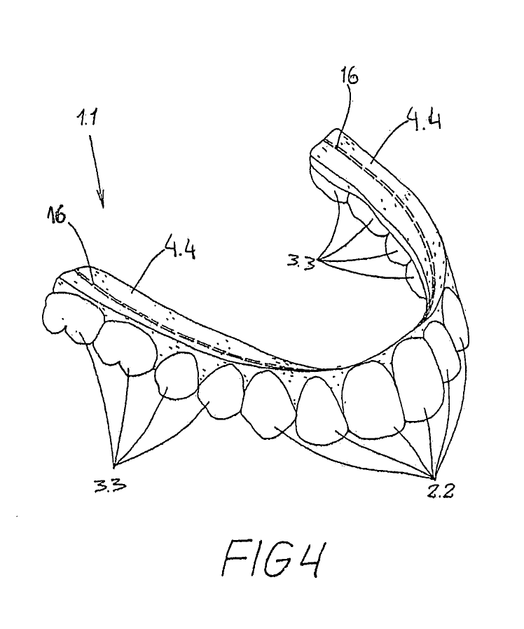

As can be seen in FIG. 4, a construction variation of the set of prefabricated and flexible dental arches with adjustable teeth is comprised of:
an upper arch 1.1 formed by upper anterior 2.2 and upper posterior 3.3 artificial teeth; and
a lower arch (not illustrated) formed by lower anterior and posterior artificial teeth (not illustrated).

Said upper artificial teeth 2.2 and 3.3, just as the lower artificial teeth, not shown in the Figures, are mounted in an orderly fashion on the upper and lower flexible support bases 4.4 (not illustrated), respectively, made of elastomeric resin in the form of an arch and a metal wire 16.

This construction variation enables a reduction in the quantity of elastomeric resin due to the metal wire 16 used to form the flexible support base 4.4. Accordingly, it is possible to avoid wear and tear of said base and to guarantee a good support.

The set of prefabricated and flexible dental arches with adjustable teeth is preferably commercialized in the form of kits. It is further possible to provide kits with complete arches, which are comprised of arches having preferably fourteen artificial teeth, and kits with arch segments, which are comprised by segments of arches having a variable amount of anterior and posterior teeth.

The set of prefabricated and flexible dental arches with adjustable teeth, and even the construction variation of the set of prefabricated and flexible dental arches with adjustable teeth allows, as stated previously, the construction of customized dentures.

The proposed process of denture construction has the advantage of saving time in the confection of dentures and consequently reduces cost compared to traditional production methods, due to the elimination of the procedure of mounting the artificial teeth one by one, which requires a long time.

Obviously, said process uses the set of prefabricated and flexible dental arches with adjustable teeth, or even a construction variation of the set of prefabricated and flexible dental arches with adjustable teeth, and is preferably based on the neutral zone technique, because the functional techniques require the use of pliable materials that can be adapted to the oral structures of the edentulous patient. However, other conventional and simplified techniques for denture construction can also be used.

The procedures of primary and secondary impressions, construction of plaster casts and recording bases, determination of neutral zone and occlusal plane, recording of intermaxillary relations and definition of the reference lines should be conventionally carried out by the dental surgeon.

In the laboratory, after mounting the plaster casts on the articulator and construction of the buccal end lingual matrices to serve as a guide for positioning the teeth, as in the neutral zone technique, the professional or technician may begin the use of prefabricated flexible dental arches 1 and 5 with adjustable teeth in the denture construction process.

To apply the arches, the arrangement should begin by the lower arch 5.

The procedure of applying said lower arch 5 begins with the transfer of the median line drawn on upper plane to the buccal matrix, which represents the artificial cheek.

Next, the reference being the line defined to position the central incisors, the diameter and form of the representative arches 9, 10, 11 of the lower arch 5 is adjusted in accordance with the configuration established by the tongue and cheek matrices.

Said adjustment of the diameter and form of the representative arches 9, 10 and 11 of the lower arch 5 is carried out manually, preferably at an approximate temperature of 25° Celsius, due to the pliability of the material, which makes up the flexible support base 8 of the lower arch 5.

The lower anterior 6 teeth should be positioned to be in contact with the cheek matrix to provide labial support and the lower posterior teeth 7 at an intermediate distance between the tongue and the cheek.

The vertical positioning is established by the contact of the artificial teeth 6 and 7 of the lower arch 5 with the occlusal plane 12 and 13. Adjustments can be made by means of wear of the flexible support base 8 or of the basal surface 15 of the artificial teeth 6 and 7 of the lower arch 5 with bur so that said lower arch 5 adapts to the space. Subsequently, the lower arch 5 should be attached with wax to the respective recording base, noting the spatial guidance provided by the median line, tongue, cheek and occlusal plane.

The upper arch 1 is adjusted by intercuspation with the lower arch 5, previously mounted and in accordance with its configuration. When the occlusal pattern “tooth against two teeth” is established, by juxtaposition between the arches 1 and 5, the arches should be attached with sticky wax.

Thereafter, the upper member of the articulator, which is not illustrated in the appended Figures, is lowered and, if necessary, adjustments to adapt the upper arch 1 to the upper recording base can be made by wear of the flexible support base 4 or of the basal surface 14 of the artificial teeth 2 and 3 of the upper arch 1.

Next, the space existing between the upper arch 1 and the upper recording base is filled with wax. The waxing should cover the entire surface of the flexible support bases 4 and 8, by vestibular and lingual.

After this procedure, any change in position of the artificial teeth 2 and 3, as may be necessary, can be made by routine laboratory maneuvers. Normally, said maneuvers consist of heating the wax spatula in an alcohol lamp flame, or in a Bunsen burner, and its subsequent introduction around the cervical and interproximal areas of the tooth to secure release.

With the fusion of the elastomeric resin and the wax to secure fixing, the artificial teeth 2, 3, 6 and 7 can be moved until the desired position is achieved, which in turn will be kept in place through solidification of the wax. It is thus possible to perform three-dimensional movements, changing the alignment, inclination and the horizontal or vertical position of the artificial teeth 2, 3, 6 and 7 during the arrangement of the upper 1 and lower 5 arches.

In succession, a wax trial denture is made. If the need arises during this stage, adjustments can be made to the position of the artificial teeth 2, 3, 6 and 7 to correct any problems relating to phonetics, aesthetics or occlusion.

Once the denture is approved, the external impressions to make the thickness and shape of the polished surfaces of the denture base compatible to the morphology and physiology of the surrounding structures, is carried out conventionally, as is the wax carving of the papillas and the processing of the acrylic dentures.

During this stage, when the flexible support bases 4 and 8 are constructed of temporary elastomer materials, in the flask opening for cleaning the wax, the flexible support base material 4 and 8 should also be removed. Said removal is by physical and chemical means, before the pressing of heat-curing acrylic resin that will constitute the definitive denture base.

The above description of this present invention was presented as an illustration and description. Furthermore, the description is not intended to limit the invention to the form disclosed herein. Consequently, variations and modifications compatible with the teachings above and the ability of knowledge of the relevant art are within the scope of this present invention.

Furthermore, the elastomeric material used may have temporary or definitive characteristics varying in accordance with the chemical composition used to make said material.

The use of definitive elastomeric material to make dentures further streamlined in the manufacturing process.

The manufacturing process of the denture can be the same one as when using temporary elastomeric material or the production thereof by any other method.

The constructive variables are in the final steps which obviously must be worked on to anneal the polymer used. Accordingly:

Once the denture is made, it must be hot-polymerized or photopolymerized. It is submitted to heat to provide the polymerization of the arch material, making it rigid and the fusion/softening of the provisional materials used in the process of manufacturing the denture.

There are also constructive variations designed to facilitate and specify the applicability of the present technology.

The flexible dental arches, the object of the present patent of invention, are also applicable in the process of manufacturing implant-retained dentures; total implant-supported dentures and total implant-supported dentures made of definitive hot-polymerizable or photopolymerizable elastomeric materials.

### EXAMPLE 1

### Technique of Applying Prefabricated Dental Arches Constituted of Flexible Bases Made of Hot-Polymerizable Definitive Elastomeric Material in the Process of Manufacturing Implant-Retained Dentures:

To manufacture implant-retained dentures, regardless of the retention system used (bar-clip, o'ring, magnet, ERA, CEKA-REVAX, milled bar, etc.) the initial procedures, involving the manufacturing of the diagnostic dentures (with the use of arches), surgical guide, placement of the implants and intermediaries, should be carried out conventionally by the dental surgeon.

After making the casts, obtaining the models, making the provisional bases, determining and recording the neutral zone and intermaxillary relations, mounting the casts on the articulator and manufacturing the vestibular and lingual matrices to act as a guide for the positioning of the teeth, in accordance with the neutral zone technique, the professional or technician can begin to use the prefabricated dental arches flexible constituted of hot-polymerizable elastomeric material in the process of making the dentures.

To apply the arches, initially, the surfaces of the flexible bases should receive the protection of a detachable isolation layer. Assembly should begin by the lower arch, transferring the average line drawn in the upper plane to the vestibular matrix, which represents the artificial cheek. Next, using as reference the line marked for positioning the central incisors, the diameter and shape of the lower arch is adjusted according to the configuration established by the tongue and cheek matrices. This is performed manually at room temperature, due to the malleability of the material of which the flexible base of the arch is made. The front teeth should be positioned in contact with the cheek matrix to provide labial support and the back teeth at an intermediary distance between the tongue and cheek. The vertical positioning is established by contact of the teeth with the occlusal plane, and adjustments can be made with drills, wearing the flexible base or basal surface of the lower teeth so that the arch adapts to the space. Subsequently, the arch should be attached with low fusion bonder to the respective provisional base, according to the spatial guidance provided by the median line, tongue, cheek and occlusal plane.

The adjustment of the upper dental arch is by intercuspation with the lower arch, previously arranged and in accordance with its shape. When the occlusal pattern “tooth against two teeth” is established, by juxtaposition between the arches, the arches should be attached with sticky wax. Thereafter, the upper member of the articulator is lowered and, if necessary, adjustments to adapt the arch to the provisional base can be made by wearing the base or the basal surface of the upper teeth. Next, the space existing between the arch and the upper provisional base is filled with low fusion bonder.

After this procedure, any change in position of the teeth, as may be necessary, can be made by loosening the tooth by the use of drills or cutting instrument and filling in the space generated with hot-polymerizable resin. It is thus possible to perform three-dimensional movements, changing the alignment, inclination and the horizontal or vertical position of the tooth during the arrangement of the arch. In succession, a trial denture is made. If the need arises during this stage, adjustments can be made to the position of the teeth to correct any problems relating to phonetics, aesthetics or occlusion, as described previously.

Once the denture is approved, the base is sculpted with wax. The denture is placed in a muffle furnace using conventional techniques and then submitted to heating, polymerizing the arch material, making it rigid and the fusion/softening of the bonder and the wax used to attach the arches and sculpture. When the flask opening for cleaning is made, the definitive base material remains, and at this point it is necessary to remove the protective isolation layer covering the surface of the base of the arches. This is done by physical and chemical means, before the pressing of heat-curing acrylic resin; next, the denture is polymerized.

In the denture installment session, the capture of the fitting systems should be in accordance with the manufacturer's guidelines. Subsequently, the occlusal adjustment is performed.

### EXAMPLE 2

### Technique of Applying Prefabricated Dental Arches Constituted of Flexible Bases Made of Temporary Elastomeric Material for Making Total Implant-Supported Dentures

To manufacture total implant-supported dentures, the initial procedures of making the diagnostic dentures (with the use of arches), surgical guide, placement of implants and intermediaries, should be performed conventionally by the dental surgeon, regardless of whether the cases are planned for two surgical steps or immediate loading.

After making the casts, obtaining the models, mounting the casts on the articulator, the metallic structure of the denture can be obtained by casting, by soldering prefabricated bars, by the use of prefabricated prosthetic systems or by milling, according to the professional's preference.

Recording the intermaxillary relations and remounting the casts on the articulator should be carried out and in the next step the prefabricated dental arches will be used in substitution of the individual mounting of the teeth. Accordingly, adjustments should be made to the arch by way of wearing with drills on the flexible base and on the surface of the teeth, so that it adapts to the space existing between the metallic structure and the teeth opposite that are part of the diagnostic denture. The arch shape is adjusted manually and to room temperature by intercuspation with the previously mounted opposite arch, in accordance with its shape and noting the spatial guidance provided by the median line, and the occlusal plane of the diagnostic denture. When the occlusal pattern “tooth against two teeth” is established, by juxtaposition between the arches, the arch should be fixed to the metallic structure with wax. The waxing should cover the entire surface of the elastomeric resin base by vestibular and lingual in both arches.

After this procedure, any change in the position of the teeth, as may be necessary, can be made by routine laboratory maneuvers. Normally, said maneuvers consist of heating the wax spatula in an alcohol lamp flame and its subsequent introduction around the cervical and interproximal areas of the tooth to secure release. With the fusion of the elastomeric resin and the wax to secure fixing, the tooth can be moved until the desired position is achieved, which in turn will be kept in place through solidification of the wax. It is thus possible to perform three-dimensional movements, changing the alignment, inclination and the horizontal or vertical position of the tooth during the arrangement of the arch.

In succession, a wax trial denture is made. If the need arises during this stage, adjustments can be made to the position of the teeth to correct any problems relating to phonetics, aesthetics or occlusion.

Once the denture is approved, the sculpting and polymerization of the denture base is carried out conventionally. During this stage, when the flask opening for cleaning the wax is made, the temporary elastomeric material which constitutes the flexible base should also be removed. Said removal is by physical and chemical means, before the pressing of heat-curing acrylic resin that will constitute the definitive denture base. After finishing, the denture should be installed and the occlusal adjustment made.

### EXAMPLE 3

### Technique of Applying Prefabricated Dental Arches Constituted by Flexible Bases Made of Hot-Polymerizable and Photopolymerizable Definitive Elastomeric Materials to Manufacture the Total Implant-Supported Dentures

To manufacture total implant-supported dentures, the initial procedures of making the diagnostic dentures (with the use of arches), surgical guide, placement of the implants and intermediaries, should be carried out conventionally by the dental surgeon, regardless of whether the cases are planned for two surgical steps or immediate loading.

After making the casts, obtaining the models, mounting the casts on the articulator, the metallic structure of the denture can be obtained by casting, by soldering prefabricated bars, by the use of prefabricated prosthetic systems or by milling, according to the professional's preference.

After recording the intermaxillary relations and remounting the casts on the articulator, the prefabricated dental arches will be used in substitution of the individual mounting of the teeth. Accordingly, adjustments should be made to the arch by way of wearing with drills on the flexible base and on the surface of the teeth, so that it adapts to the space existing between the metallic structure and the teeth opposite that are part of the diagnostic denture. The arch shape is adjusted manually and to room temperature by intercuspation with the previously mounted opposite arch, in accordance with its shape and noting the spatial guidance provided by the median line, and the occlusal plane of the diagnostic denture.

When the arches are constituted of hot-polymerizable elastomeric material, when the occlusal pattern “tooth against two teeth” is established, by juxtaposition between the arches, the arch should be attached to the metallic structure with hot-polymerizable resin.

After this procedure, any changes in the position of the teeth as may be necessary, can be carried out by loosening the tooth by the use of drills or cutting instrument and filling in the space generated with hot-polymerizable resin. It is thus possible to perform three-dimensional movements, changing the alignment, inclination and the horizontal or vertical position of the tooth during the arrangement of the arch. In succession, a trial denture is made. If the need arises during this stage, adjustments can be made to the position of the teeth to correct any problems relating to phonetics, aesthetics or occlusion, as described previously.

Once the denture is approved, the gums are formed by applying hot-polymerizable resins using the powder/liquid system to reproduce the colors and contours of the gums, giving the bases a natural appearance. Next, the denture is placed in a muffle furnace and polymerized, wherein the definitive material of which its basis is constituted also becomes rigid.

When the arches are constituted of photopolymerizable elastomeric material, when the occlusal pattern “tooth against two teeth” is established, by juxtaposition between the arches, the arch should be attached to the metallic structure with photopolymerizable resin.

After this procedure, any change of position of the teeth as may be necessary can be made by loosening the tooth by the use of drills or cutting instrument and filling in the space generated with photopolymerizable resin. It is thus possible to perform three-dimensional movements, changing the alignment, inclination and the horizontal or vertical position of the tooth during the arrangement of the arch. In succession, a trial denture is made. If the need arises during this stage, adjustments can be made to the position of the teeth to correct any problems relating to phonetics, aesthetics or occlusion, as described previously.

Once the denture is approved, the gums are sculpted by applying photopolymerizable resin in paste and fluid in order to reproduce the colors and contours of the gums, giving the bases a natural appearance. Next, the denture is polymerized in a photopolymerization chamber, the definitive material of which its base is constituted also becoming rigid. After finishing, the denture should be installed and the occlusal adjustment performed.

The embodiments described above are intended to provide a clearer explanation of the known ways to carry out this invention and to enable one skilled in the art to use the invention in these or other embodiments and with various modifications necessary for the specific applications or uses of the present invention. It is intended that the present invention should include all modifications and variations hereof, within the scope described in the specification.

1. Set of prefabricated and flexible dental arches with adjustable teeth, characterized by comprising:
an upper arch 1, formed by upper anterior 2 and upper posterior 3 artificial teeth, mounted in an orderly fashion on a first flexible support base 4;
a lower arch 5, formed by lower anterior 6 and lower posterior 7 artificial teeth, mounted in an orderly fashion on a second flexible support base 8.

2. Set of dental arches according to claim 1, characterized wherein the flexible support bases 4 and 8 are made of an elastomeric resin in the form of an arch, substantially similar to natural upper and lower dental arches, having three-dimensional movement capacity to enable alterations to the diameter and form of the representative dental arches 9, 10 and 11, and to the inclination of the occlusal plane 12 and 13 to allow adaptation to the anatomy and physiology of the patient's oral cavity and so that any occlusal pattern can be obtained during the arrangement.

3. Set of dental arches according to claim 1, characterized by enabling adjustments to be made to each tooth individually, by way of changes of position, inclination or alignment, in order to correct aesthetic, phonetic or occlusal problems.

4. Set of dental arches according to claim 1, characterized wherein the artificial teeth 2, 3, 6 and 7 can be made of synthetic resin.

5. Set of dental arches according to claim 1, characterized wherein the artificial teeth 2, 3, 6 and 7 can be made of porcelain.

6. Set of dental arches according to claim 1, characterized wherein the upper artificial teeth 2 and 3 and the lower artificial teeth 6 and 7 can be temporarily attached to the flexible support base 4 and to the second flexible support base 8, respectively by mechanical retention means, obtained by the presence of a cavity in the basal surface of each tooth.

7. Set of dental arches according to claim 1, characterized wherein the upper artificial teeth 2 and 3 and the lower artificial teeth 6 and 7 can alternatively be attached definitively to the first flexible support base 4 and to the second flexible support base 8, respectively by mechanical retention means, obtained by the presence of a cavity in the basal surface of each tooth.

8. Set of dental arches according to claim 1, characterized wherein all the commercially available artificial teeth molds according to their specific manufacturing characteristics can be used in dental arches 1 and 5.

9. Set of dental arches according to claim 1, characterized by being applicable to any kind of occlusal anatomy for the posterior teeth, including variations in inclination in the cusps slopes.

10. Set of dental arches according to claim 1, characterized by being produced with the artificial teeth 2, 3, 6 and 7 preferably aligned in templates provided with a negative impression of the occlusal surfaces and axial contours of the respective teeth.

11. Set of dental arches according to claim 1, characterized wherein the arches 1 and 5 are alternatively segmented having a base made of elastomer and comprised by arch segments formed by teeth of the anterior sextants and of the posterior quadrants.

12. Set of dental arches according to claim 1 characterized wherein the segmented arches are alternatively comprised of arch segments formed solely by teeth of the anterior sextants.

13. Set of dental arches according to claim 1, characterized wherein the segmented arches are alternatively comprised of arch segments formed solely by teeth of the posterior quadrants.

14. Set of dental arches according to claim 1, characterized by a construction variation of said set to facilitate the adaptation of the arches to the patient's vertical dimension and to enable a reduction in the quantity of the elastomeric resin, comprising:
an upper arch 1.1 formed by upper anterior 2.2 and upper posterior 3.3 artificial teeth; and
a lower arch formed by lower anterior and posterior artificial teeth.

15. Set of dental arches according to claim 1, characterized wherein said upper artificial teeth 2.2, 3.3 are mounted in an orderly fashion on the flexible support bases 4.4 made of elastomeric resin in the form of an arch and a metal wire 16.

16. Set of dental arches according to claim 1, characterized wherein said lower artificial teeth are mounted in an orderly fashion on the flexible support bases made of elastomeric resin in the form of an arch and a metal wire 16.

17. Set of dental arches according to claim 1, characterized by enabling customized denture construction.

18. Kit of prefabricated, flexible dental arches, with adjustable teeth, characterized by comprising a variable amount of anterior and posterior teeth.

19. Kit, according to claim 18, characterized by comprising complete arches preferably comprised of fourteen artificial teeth.

20. Kit of dental arches according to claim 18, characterized by comprising segmented arches having a variable amount of anterior and posterior teeth.

21. Denture construction process, characterized by eliminating the stage of mounting the artificial teeth one by one.

22. Denture construction process according to claim 21, characterized wherein the arches are applied in any technique for constructing removable complete dentures.

23. Denture construction process according to claim 21, characterized wherein the arches are applied in any technique for constructing removable partial dentures.

24. Method of application of the dental arches as claimed in claim 1, characterized by using said dental arches in the arrangement begun by the lower arch 5 with the transfer of the median line drawn in the upper plane to the buccal matrix, using as reference the line defined for positioning the central incisors and carrying out the adjustment to the diameter and form of the representative arches 9, 10, 11 according to the configuration established by the tongue and cheek matrices.

25. Method of application according to claim 24, characterized wherein said adjustment can be carried out manually, preferably at an approximate temperature of 25° Celsius.

26. Method of application according to claim 24, characterized wherein the lower anterior teeth 6 are positioned to be in contact with the cheek matrix to provide labial support, the lower posterior teeth 7 at an intermediate distance between the tongue and the cheek and the vertical positioning is established by the contact of the artificial teeth 6 and 7 with the occlusal plane 12 and 13, to determine the occlusal pattern, and adjustments can be made by way of wear of the flexible support base 8 with bur.

27. Method of application according to claim 24, characterized wherein the vertical positioning is alternatively established by contact of the artificial teeth 6 and 7 with the occlusal plane 12 and 13, to determine the occlusal pattern, adjustments can be made by way of wear of the basal surface 15 with bur.

28. Method of application according to claim 24, characterized wherein the lower arch 5 is attached with wax to the respective recording base, according to the spatial guidance provided by the median line, tongue, cheek and occlusal plane.

29. Method of application according to claim 24, characterized wherein the upper arch 1 is adjusted by intercuspation with the lower arch 5, previously mounted and in accordance with its configuration.

30. Method of application according to claim 24, characterized wherein after determining the occlusal pattern by juxtaposition of the arches 1 and 5, the arches should be attached with sticky wax.

31. Method of application according to claim 24, characterized wherein the upper member of the articulator is lowered and, if necessary, adjustments are made to adapt the upper arch 1 to the upper recording base by way of wear of the flexible support base 4 of the upper arch 1.

32. Method of application according to claim 24, characterized wherein the upper member of the articulator is lowered and, if necessary, adjustments are made to adapt the upper arch 1 to the upper recording base by way of wear of the basal surface 14 of the artificial teeth 2 and 3.

33. Method of application according to claim 24, characterized wherein the space existing between the upper arch 1 and the temporary upper base is filled with wax.

34. Method of application according to claim 24, characterized wherein any alteration of position of the artificial teeth 2, 3, 6 and 7 as necessary can be made by routine laboratory maneuvers.

35. Set of prefabricated and flexible dental arches characterized wherein the elastomeric polymer used to make it can be temporary or definitive.

36. Set of prefabricated and flexible dental arches, according to claim 1, characterized wherein the annealing of the definitive elastomeric polymer is by hot-polymerization or by photopolymerization.

37. Set of prefabricated and flexible dental arches characterized by use in the manufacture of implant-retained dentures, being composed of hot-polymerizable definitive elastomeric material.

38. Set of prefabricated and flexible dental arches characterized by use in the manufacture of total implant-supported dentures, being composed of temporary elastomeric material.

39. Set of prefabricated and flexible dental arches characterized by use in the manufacture of total implant-supported dentures, being composed of hot-polymerizable or photopolymerizable definitive elastomeric material.
